(19) United States
(12) Patent Application Publication
(10) Pub. No.: US 2017/0331568 A1
(43) Pub. Date: Nov. 16, 2017

(54) APPARATUS AND METHOD FOR INTERFERENCE ALIGNMENT IN CELLULAR COMMUNICATION NETWORK

(71) Applicant: Electronics and Telecommunications Research Institute, Daejeon (KR)

(72) Inventors: Jin Hyung OH, Sejong-si (KR); Myung Sun SONG, Daejeon-si (KR); Heon Jin Hong, Daejeon-si (KR)

(73) Assignee: Electronics and Telecommunications Research Institute, Daejeon (KR)

(21) Appl. No.: 15/442,341

(22) Filed: Feb. 24, 2017

(30) Foreign Application Priority Data
May 11, 2016 (KR) 1020160057731

(51) Int. Cl. H04B 17/345; H04L 12/24; H04W 16/28; H04W 72/04

(52) U.S. Cl. CPC H04B 17/345; H04W 72/04; H04L 41/12; H04W 16/28

(57) ABSTRACT

An apparatus for interference alignment in a cellular communication network includes a preparation message receiver configured to receive interference alignment preparation messages from receivers; a grouper configured to group the receivers with reference to the received interference alignment preparation messages according to an interference alignment algorithm; and an interference aligner configured to perform interference alignment based on a bandwidth secured for the receivers.

### CROSS-REFERENCE TO RELATED APPLICATION(S)

This application claims the benefit under 35 USC §119(a) of Korean Patent Application No. 10-2016-0057731, filed on May 11, 2016, in the Korean Intellectual Property Office, the entire disclosure of which is incorporated herein by reference for all purposes.

### BACKGROUND

### 1. Field

The following description relates to cellular communications, and more particularly, to an apparatus and method for interference alignment.

### 2. Description of Related Art

In a cellular communication network which is based on limited frequency resources, frequency efficiency improvement is a top priority.

One of typical methods to improve frequency efficiency is frequency re-use, by which geographically remote cells are allowed to use the same frequencies, thereby improving the frequency efficiency without interference between the cells. Such frequency re-use scheme is, however, merely the most basic form of an operation scheme, rather than a technology for substantially improving the frequency efficiency.

Another method to improve frequency efficiency is to increase a modulation order. For example, as shown in binary-phase shift keying (BPSK), quadrature phase shift keying (QPSK), 16-quadrature amplitude modulation (16QAM), 64QAM, and 256QAM for the 5G mobile communication technology, the number of bits that are mapped to one symbol in a physical layer (PHY) increases from 1 to 8, and, in turn, the amount of data that can be transmitted at one time also increases, which may lead to the frequency efficiency improvement.

In addition, with the recent use of multiple antennas at a receiver and a transmitter, a multi-user multiple-input and multiple-output (MIMO) space division multiplexing technology and a multi-user (MU)-MIMO technology based on such multiple antennas have been suggested, which allow additional frequency efficiency. Currently, the frequency efficiency improvement through the multiple antennas can be achieved when a plurality of different streams are transmitted using the same frequencies at the same time in the same cell.

The above-described methods for improving frequency efficiency are applied to the same cell, whereas a new scheme, so called, ComP, for the long-term evolution (LTE)-Advanced standard, has been suggested to improve frequency efficiency over the entire network by cooperation between adjacent cells. For example, if transmitters in adjacent cells cooperate with each other to transmit data to a user located at the boundary between said cells, more stable transmission is possible, and accordingly, the frequency efficiency can be improved.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an apparatus and method for interference alignment in a cellular communication network, such that an innovative interference alignment technology that goes beyond the existing frequency efficiency improvement schemes is applied to a cellular communication environment.

In one general aspect, there is provided an apparatus for interference alignment in a cellular communication network, the apparatus including: a preparation message receiver configured to receive interference alignment preparation messages from receivers; a grouper configured to group the receivers with reference to the received interference alignment preparation messages according to an interference alignment algorithm; and an interference aligner configured to perform interference alignment based on a bandwidth secured for the receivers.

The interference alignment preparation message may include a number of antennas and information to indicate whether the receiver participates in interference alignment.

The grouper may group the receivers according to a number of receivers participating in interference alignment and a number of antennas, which are identified from the interference alignment preparation messages.

The apparatus may further include an applicability determiner configured to determine whether or not it is possible to apply a predetermined interference alignment algorithm by taking into consideration the identified numbers of receivers participating in interference alignment and antennas, and a bandwidth divider configured to divide the secured bandwidth into sub-bands according to the determination by the applicability determiner, and distribute the receivers over the sub-bands.

The interference alignment preparation message may further include comprise a reference signal and the interference aligner obtains downlink channel information from the reference signal.

The interference alignment preparation message may include information about an address of a nearby transmitter that affects the receiver.

In another general aspect, there is provided a method of interference alignment in a cellular communication network, the method including: receiving interference alignment preparation messages from receivers; grouping the receivers with reference to the received interference alignment preparation messages according to an interference alignment algorithm; and performing interference alignment based on a bandwidth secured for the receivers.

The interference alignment preparation message may include a number of antennas and information to indicate whether the receiver participates in interference alignment.

The grouping of the receivers may be performed according to a number of receivers participating in interference alignment and a number of antennas, which are identified from the interference alignment preparation messages.

The method may further include determining whether or not it is possible to apply a predetermined interference alignment algorithm by taking into consideration identified numbers of receivers participating in interference alignment and antennas, and dividing the secured bandwidth into sub-bands according to the determination and distributing the receivers over the sub-bands.

The interference alignment preparation message may further include a reference signal and the performing of the interference alignment comprises obtaining downlink channel information from the reference signal.

Other features and aspects will be apparent from the following detailed description, the drawings, and the claims.

### BRIEF DESCRIPTION OF THE DRAWINGS

FIG. 1 is a diagram illustrating a resource block map for a long-term evolution (LTE) single cell according to a downlink multiple access method.

FIG. 2 is a diagram illustrating, from the viewpoint of a network, the resource block map for an LTE single cell according to the downlink multiple access method.

FIG. 3 is a diagram illustrating resource allocation to which multi-user multiple-input and multiple-output (MU-MIMO) technology for LTE-A is applied.

FIG. 4 is a diagram illustrating a resource block map to which adjacent cells apply interference alignment in an MU-MIMO environment.

FIG. 5 is a diagram illustrating one embodiment of a cellular communication network in which each cell operates as an MU-MIMO in order to utilize interference alignment.

FIG. 6 is a block diagram illustrating a transmitter using interference alignment in a cellular communication network according to one exemplary embodiment.

FIG. 7 is a diagram illustrating a preparation message for interference alignment according to one exemplary embodiment of the present invention.

FIGS. 8A to 8C are diagrams illustrating various exemplary embodiments of bandwidth division for interference alignment.

FIG. 9 is a flowchart illustrating a method of interference alignment in a cellular communication network according to one exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

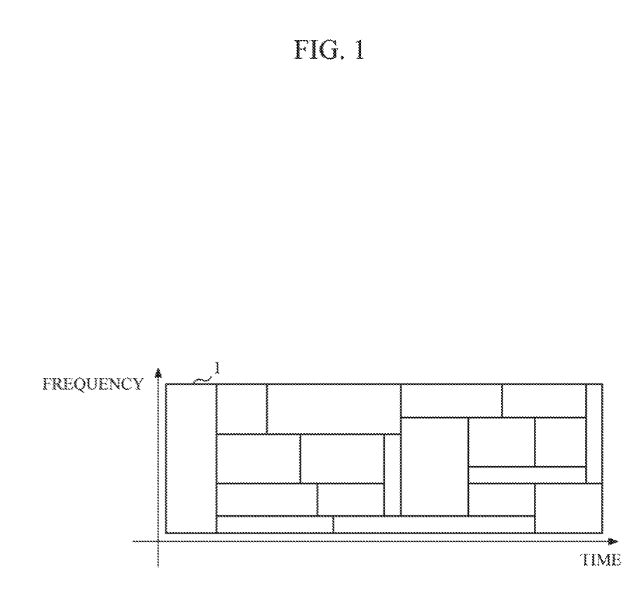

FIG. 1 is a diagram illustrating a resource block map for an LTE single cell according to a downlink multiple access method.

Referring to FIG. 1, the downlink multiple access method is based on Orthogonal Frequency Division Multiple Access (OFDMA) in which time and frequency resources are both used by allocating a resource block 1 (hereinafter, referred to as an “RB”) consisting of time and frequency resources. Since both time and frequency resources are used to allocate radio resources to users, the downlink multiple access method is considered as the most effective form of multiplexing so far. However, in this method, data is transmitted only to a specific user through the RB 1, and thus, if data can be transmitted to multiple users through the RB 1, the frequency efficiency would be more improved.

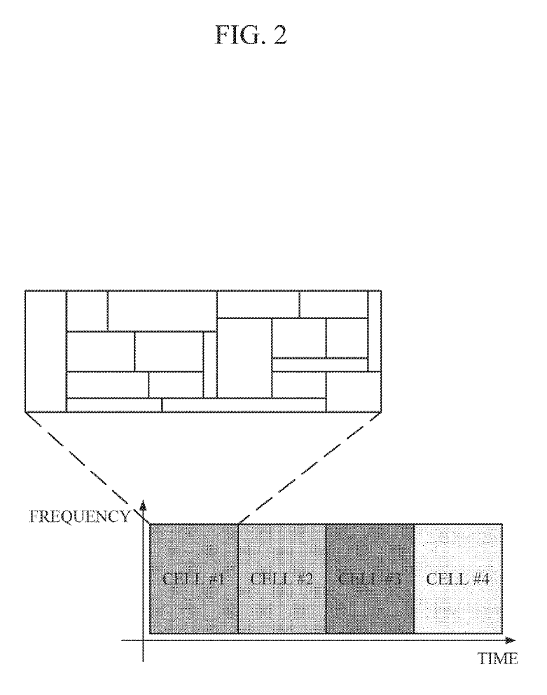

FIG. 2 is a diagram illustrating, from the viewpoint of a network, the resource block map for an LTE single cell according to the downlink multiple access method.

Referring to FIG. 2, it is expected that a communication service provider that sets aside a wideband frequency will efficiently use the frequency with minimum interference and hence will independently allocate radio resources to adjacent cells. In FIG. 2, time resources are exclusively allocated to the cells, and frequency resources may be allocated in the same manner.

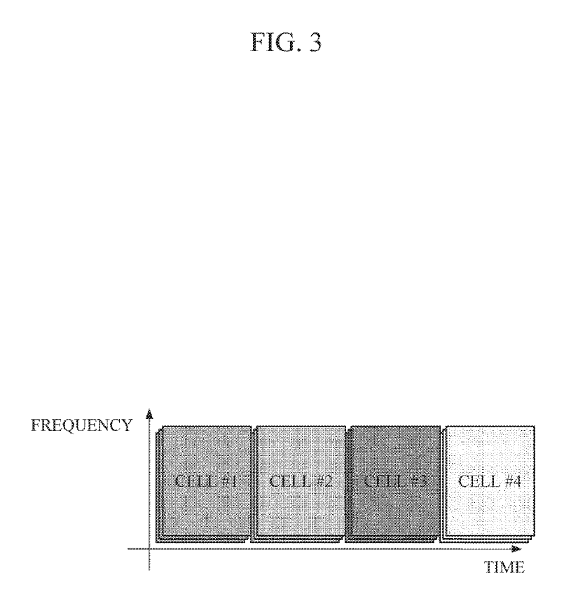

FIG. 3 is a diagram illustrating resource allocation to which multi-user multiple-input and multiple-output (MU-MIMO) technology in LTE-A is applied.

Referring to FIG. 3, the frequency efficiency is improved more than that in the environment of FIG. 2. In this case, efficiency of frequency available to each cell increases in proportion to the number of nodes participating in MU-MIMO. FIG. 3 is depicted under the assumption that interference between adjacent cells that perform MU-MIMO using time and frequency resources is controlled. An overlap between cells represents a resource map as shown in FIG. 1. The resource maps overlap between the cells because data is transmitted to multiple users using the same frequency at the same time through MU-MIMO.

The above descriptions with reference to FIGS. 1 to 3 are provided based on the current LTE-A standard. In the present invention, interference alignment is used to improve the frequency efficiency. The interference alignment allows transmitters in adjacent regions to transmit signals using the same frequency band at the same time without interference, and more specifically, uses spatial resources of multiple antennas and allows a receiver to receive a desired signal without interference, by allocating an interfering signal to a specific spatial resource through precoding and decoding procedures.

Fundamentally, in order to utilize the interference alignment technology in an effort to improve frequency efficiency, it is important to use interference that occurs among adjacent cells. Recently, with an increasing attention to small cells, spacing between cells has been reduced and, in turn, an overlapping area of cells has increased, so that the amount of interference among adjacent cells has increased. However, it is anticipated that the interference alignment technology will allow such interferences to be used to improve the frequency efficiency.

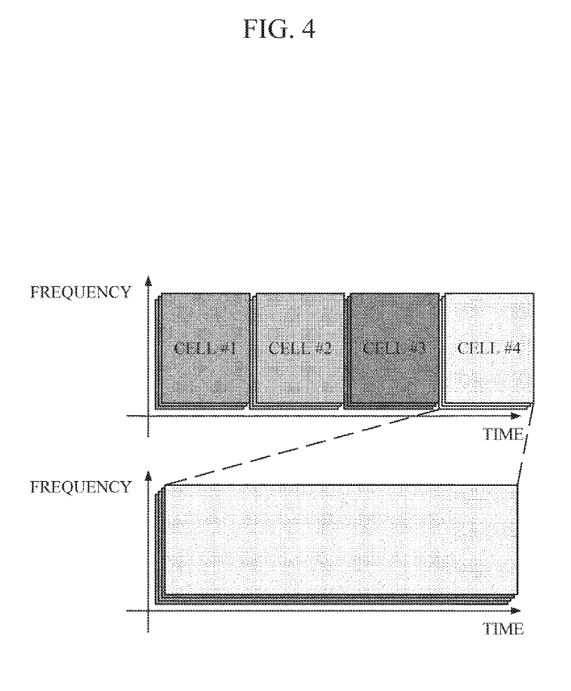

FIG. 4 is a diagram illustrating a resource block map to which adjacent cells apply interference alignment in an MU-MIMO environment.

Referring to FIG. 4, upper cells operate each as an MU-MIMO, and resource blocks when interference alignment is performed on adjacent cells are depicted below thereof. FIG. 4 is depicted under the assumption that interference alignment has been performed, so that different adjacent cells that perform MU-MIMO at the same time and cover all frequency bands can perform transmission simultaneously.

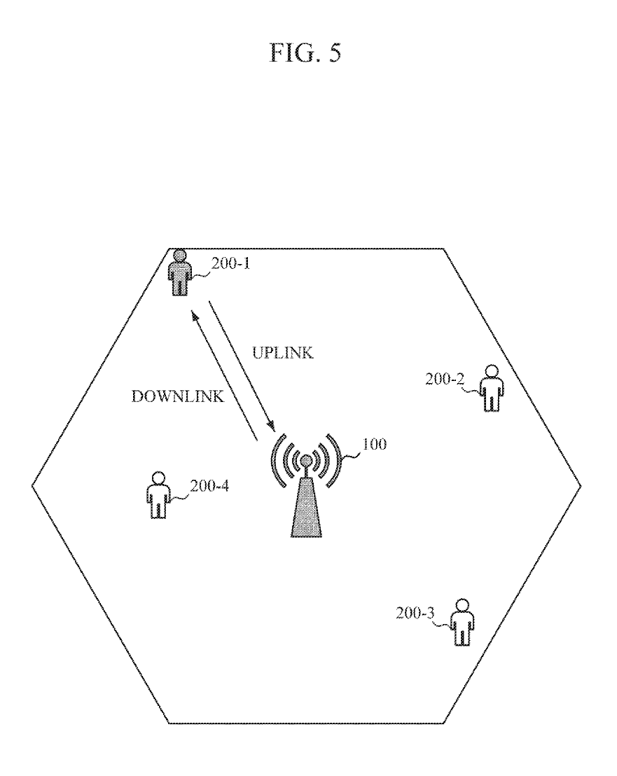

FIG. 5 is a diagram illustrating an example of a cellular communication network in which each cell operates as an MU-MIMO in order to utilize interference alignment.

Referring to FIG. 5, one cellular communication base station apparatus 100 communicates with mobile terminals 200-1, 200-2, 200-3, and 200-4 which are owned by multiple users. The cellular communication base station apparatus 100 and the mobile terminals 200-1, 200-2, 200-3, and 200-4 may be equipped with multiple antennas and operate as an MU-MIMO. Here, a transmission link from the mobile communication base station apparatus 100 to the mobile terminals 200-1, 200-2, 200-3, and 200-4 is referred to as a downlink, and a transmission link from the mobile terminals 200-1, 200-2, 200-3, and 200-4 to the mobile communication base station apparatus 100 is referred to as an uplink. According to one aspect, the cellular communication base station apparatus 100 transmits data to the mobile terminals 200-1, 200-2, 200-3, and 200-4 using the interference alignment. Hence, for convenience of description, the cellular communication base station apparatus 100 will be herein referred to as a “transmitter” and the mobile terminals 200-1, 200-2, 200-3, and 200-4 will be referred to as “receivers”.

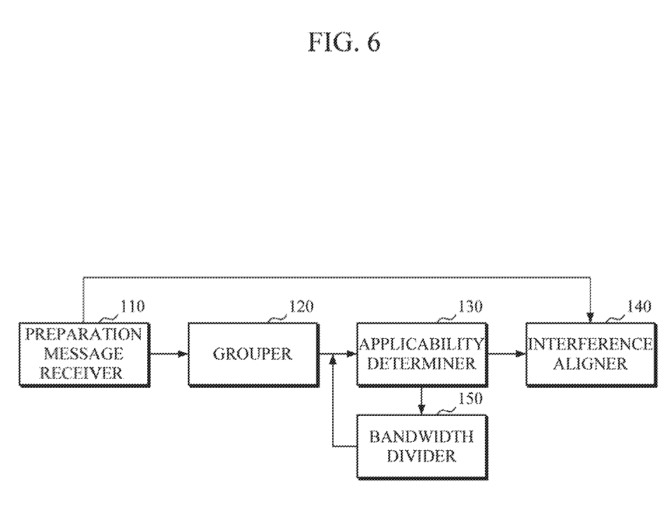

FIG. 6 is a block diagram illustrating a transmitter using interference alignment in a cellular communication network according to one exemplary embodiment.

Referring to FIG. 6, the transmitter using interference alignment in a cellular communication network (hereinafter, referred to simply as a “transmitter”) includes a preparation message receiver 110, a grouper 120, an applicability determiner 130, an interference aligner 140, and a bandwidth divider 150.

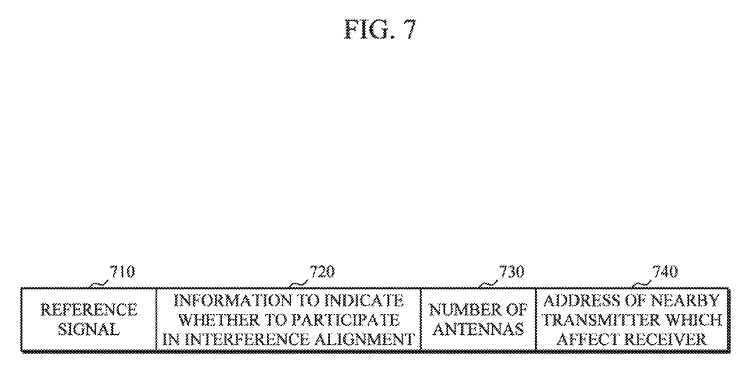

The preparation message receiver 110 receives preparation messages for interference alignment from receivers. Details of the preparation message will be described with reference to FIG. 7.

The grouper 120 identifies the number of nodes that are to participate in interference alignment and the number of antennas from the received preparation messages, and thereafter, groups the nodes and antennas for each sub-band according to an interference alignment algorithm to apply. This is because the number of receivers to which the interference alignment algorithm can be applied is limited according to the number of antennas of each of a transmitter and receivers. For example, if a particular interference alignment algorithm is designed to be operative in an environment where reciprocal interference occurs in a network consisting of one transmitter with six antennas and two receivers each of which has four antennas, interference alignment cannot be performed on the same band if another receiver with the same number of antennas is added to the network. In this case, conventionally, transmission was carried out in the event of interference occurring, or a method that increases the number of antennas of a transmitter or a method that reduces the number of antennas of a receiver was considered. However, the present invention assumes the interference alignment and solves the aforesaid problem by utilizing sub-bands over the entire frequency band.

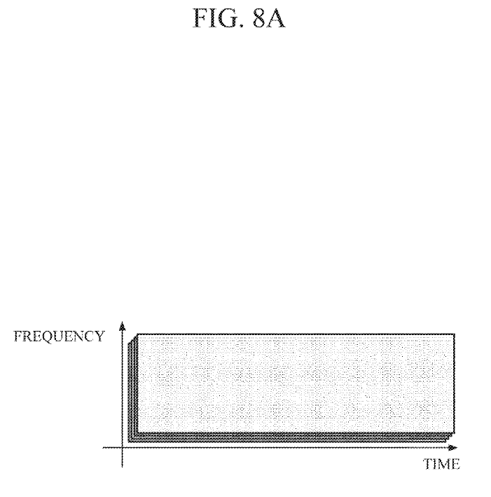

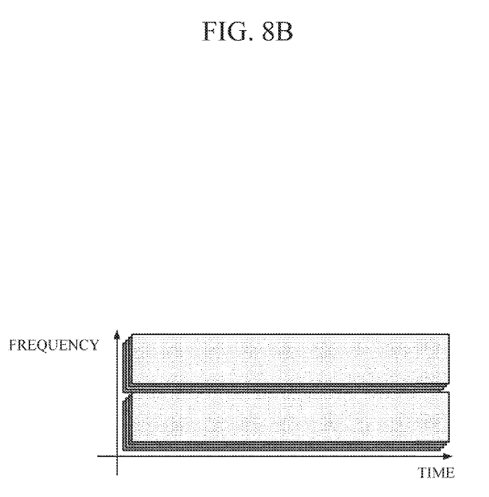

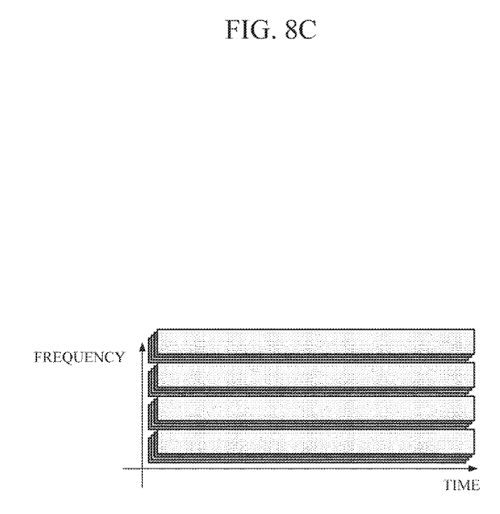

To be specific, the applicability determiner 130 determines whether the interference alignment can be performed according to the interference alignment algorithm, and in the case where the applicability determiner 130 determines that the interference alignment cannot be applied due to the numbers of nodes and antennas, the band divider 150 divides the previously secured bandwidth into sub-bands, and allocates the sub-bands to the receivers. The division of bandwidth will be described later in detail with reference to FIGS. 8A to 8C.

In response to the sub-bands being allocated to the receivers, the interference aligner 140 performs the interference alignment, regardless of the numbers of receivers participating in the interference alignment and the antennas of the receivers, and transmits data to the receivers. That is, the band divider 150 allocates the sub-bands to the receivers by taking into account the interference alignment algorithm, the number of receivers participating in the interference alignment, and the number of antennas of each receiver, it is possible to easily apply the interference alignment which was difficult to utilize according to the numbers of receivers participating in the interference alignment and antennas of the receivers.

FIG. 7 is a diagram illustrating a preparation message for interference alignment according to an exemplary embodiment of the present invention.

Referring to FIG. 7, the preparation message for interference alignment includes a reference signal 710, information 720 to indicate whether a receiver participates in interference alignment (hereinafter, will be referred to as “participation notification information”), the number of antennas 730, and an address 740 of a nearby transmitter which affects the receiver (hereinafter, will be referred to as a “nearby transmitter address”).

The reference signal 710 is information for identifying information about a channel between a transmitter and the receiver. That is, in order for the interference aligner 140 to perform interference alignment, information about a downlink channel from the transmitter 100 to the receiver is required, for which information about an uplink channel from the receiver to the transmitter 100 is identified through the reference signal 710 in the preparation message for interference alignment that the receiver has sent in a TDD system which uses the same up/downlink transmission frequencies, and the downlink channel information can be inversely obtained according to channel reciprocity. The reference signal 710 is known at both the transmitter and the receiver, and hence the channel information of a link between the transmitter and the receiver can be identified, from which an interference alignment precoding matrix can be acquired.

The participation notification information 720 includes information for interference alignment grouping, which notifies transmitter about whether the receiver itself participates in interference alignment transmission. By doing so, the grouper 120 can recognize the number of receivers to participate in the interference alignment.

The number of antennas 730 is the number of antennas of the receiver, which is important information for applying the interference alignment algorithm. Based on the information, the grouper 120 can identify the number of antennas of the receivers that are to participate in the interference alignment.

The nearby transmitter address 740 is a MAC address of a nearby transmitter that interferes with the receiver, and it is transmitted to a transmitter of a cell that the receiver belongs to in order to group the nodes that participate in the interference alignment.

FIGS. 8A to 8C are diagrams illustrating various exemplary embodiments of bandwidth division for interference alignment.

Referring to FIG. 8A, a case is shown in which an interference alignment algorithm can be applied to all bands without dividing the band into sub-bands, regardless of the number of receivers participating in interference alignment and the number of antennas of each receiver.

Referring to FIG. 8B, in a case in which it is difficult to utilize the interference alignment algorithm due to the number of receivers participating in the interference alignment and the number of antennas of each receiver, the entire band is divided into two sub-bands and the participating receivers are distributed over the sub-bands to apply the interference alignment algorithm.

Referring to FIG. 8C, if the interference alignment cannot be applied to the case of FIG. 8B, each sub-band is divided into two sub-bands in the same manner as applied to the case of FIG. 8B, and the receivers are allocated to the resulting sub-bands, whereby the interference alignment can be applied.

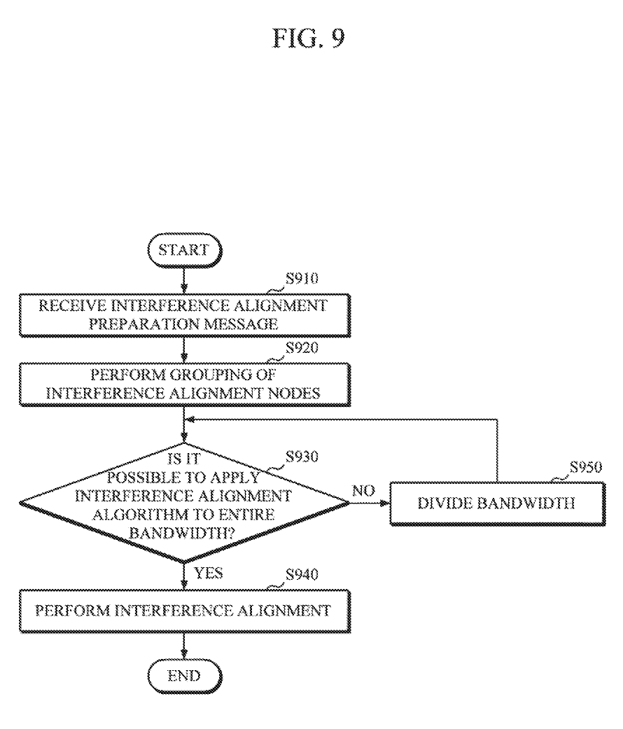

FIG. 9 is a flowchart illustrating a method of interference alignment in a cellular communication network according to an exemplary embodiment of the present invention.

Referring to FIG. 9, a transmitter receives a preparation message for interference alignment from each receiver, as depicted in S910. Here, the details of the preparation message are described with reference to FIG. 7.

The transmitter identifies the numbers of nodes participating in the interference alignment and antennas from the preparation message, and performs grouping for each sub-band according to an interference alignment algorithm to be applied, as depicted in S920. This is because the number of receivers to which the interference alignment algorithm can be applied is limited according to the number of antennas of each of a transmitter and receivers. The present invention assumes the interference alignment and solves the aforesaid problem by utilizing sub-bands over the entire frequency band.

That is, the transmitter determines whether the interference alignment can be performed according to the interference alignment algorithm by taking into account the number of receivers and the number of antennas of each receiver, as depicted in S930.

When it is determined in S930 that the interference alignment can be performed, the transmitter performs the interference alignment and transmits data to the receivers, as depicted in S940. In this case, the transmitter obtains downlink channel information using a reference signal contained in the preparation message, and performs the interference alignment using the obtained downlink channel information.

In contrast, when it is determined in S930 that the interference alignment cannot be performed, the transmitter divides a previously secured bandwidth into sub-bands and allocates the sub-bands to the receivers, as depicted in S950. For example, the bandwidth as shown in FIG. 8A can be divided into sub-bands as shown in FIG. 8B, and then allocated to the receivers. Thereafter, the transmitter determines again whether the interference alignment can be performed according to the interference alignment algorithm, as depicted in S930, and if determined that the interference alignment cannot be performed, the transmitter may further divide the sub-bands of FIG. 8B into sub-bands as shown in FIG. 8C. That is, the transmitter may repeatedly perform operations depicted in S930 to S950 until it is possible to apply the interference alignment. Thus, as the sub-bands are allocated to the receivers, the transmitter performs the interference alignment, regardless of the number of receivers participating in the interference alignment and the number of antennas of the receivers, and transmits data to the receivers. By taking into account the interference alignment algorithm, the number of receivers participating in the interference alignment, and the number of antennas of each receiver, the bandwidth is divided into sub-bands and then allocated, and accordingly, it is possible to easily perform the interference alignment which was difficult to apply according to the numbers of participating receivers and antennas of the receivers.

The present invention suggests a method that divides a previously secured bandwidth into sub-bands and allocates the sub-bands in order to apply interference alignment in a cellular environment. Applicability of existing interference alignment algorithms which have been studied depends on the number of participating nodes and the number of antennas. For this reason, it was not easy to apply the interference alignment technology, which is effective in interference control and frequency efficiency improvement, to a cellular communication environment. To address such difficulty, the present invention performs interference alignment by dividing the frequency bandwidth into sub-bands and distributing participating nodes over the sub-bands, and thereby may provide a clue to the problem of the conventional method which was limited in application depending on the number of participating nodes and the number of antennas.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for interference alignment in a cellular communication network, the apparatus comprising:
a preparation message receiver configured to receive interference alignment preparation messages from receivers;
a grouper configured to group the receivers with reference to the received interference alignment preparation messages according to an interference alignment algorithm; and
an interference aligner configured to perform interference alignment based on a bandwidth secured for the receivers.

2. The apparatus of claim 1, wherein the interference alignment preparation message comprises a number of antennas and information to indicate whether the receiver participates in interference alignment.

3. The apparatus of claim 2, wherein the grouper groups the receivers according to a number of receivers participating in interference alignment and a number of antennas, which are identified from the interference alignment preparation messages.

4. The apparatus of claim 2, further comprising:
an applicability determiner configured to determine whether or not it is possible to apply a predetermined interference alignment algorithm by taking into consideration the identified numbers of receivers participating in interference alignment and antennas; and
a bandwidth divider configured to divide the secured bandwidth into sub-bands according to the determination by the applicability determiner, and distribute the receivers over the sub-bands.

5. The apparatus of claim 1, wherein the interference alignment preparation message further comprises a reference signal and the interference aligner obtains downlink channel information from the reference signal.

6. The apparatus of claim 1, wherein the interference alignment preparation message comprises information about an address of a nearby transmitter that affects the receiver.

7. A method of interference alignment in a cellular communication network, the method comprising:
receiving interference alignment preparation messages from receivers;
grouping the receivers with reference to the received interference alignment preparation messages according to an interference alignment algorithm; and
performing interference alignment based on a bandwidth secured for the receivers.

8. The method of claim 7, wherein the interference alignment preparation message comprises a number of antennas and information to indicate whether the receiver participates in interference alignment.

9. The method of claim 8, wherein the grouping of the receivers is performed according to a number of receivers participating in interference alignment and a number of antennas, which are identified from the interference alignment preparation messages.

10. The method of claim 8, further comprising:
determining whether or not it is possible to apply a predetermined interference alignment algorithm by taking into consideration identified numbers of receivers participating in interference alignment and antennas; and
dividing the secured bandwidth into sub-bands according to the determination and distributing the receivers over the sub-bands.

11. The method of claim 7, wherein the interference alignment preparation message further comprises a reference signal and the performing of the interference alignment comprises obtaining downlink channel information from the reference signal.

12. The method of claim 7, wherein the interference alignment preparation message comprises information about an address of a nearby transmitter that affects the receiver.
